(19) United States
(12) Patent Application Publication
(10) Pub. No.: US 2012/0314023 A1
(43) Pub. Date: Dec. 13, 2012

(54) SPLIT SCREEN FOR 3D

(76) Inventors: Jesus Barcons-Palau, Burbank, CA (US); Joan Llach, Cesson Sevigne (FR)

(21) Appl. No.: 13/580,165

(22) PCT Filed: Oct. 8, 2010
(86) PCT No.: PCT/US10/02716

§ 371 Date: Aug. 21, 2012

Related U.S. Application Data
(60) Provisional application No. 61/307,734, filed on Feb. 24, 2010.

(51) Int. Cl. H04N 13/00

(52) U.S. Cl. 348/42; 348/E13.062; 348/E13.063

(57) ABSTRACT

A method, apparatus and system are provided for the visual inspection of a three-dimensional video stream as it is being re-encoded into a second video format. A portion of a frame of a decoded three-dimensional video stream and a corresponding portion of a frame of the three-dimensional video stream having been re-encoded are arranged into a combined video frame such that the video frame portions appear together in the combined video frame. A boundary between the video frame portions in the combined video frame is manipulated such that a change of disparity on the boundary between the video frame portions, and any overlap between the combined video frame portions, are not visible.

### CROSS-REFERENCE TO RELATED APPLICATIONS

This application claims the benefit of U.S. Provisional Application Ser. No. 61/307,734, filed Feb. 24, 2010, which is incorporated by reference herein in its entirety.

### FIELD OF THE INVENTION

The present invention generally relates to visual assessment of 3D content and, more particularly, to a method, apparatus and system for implementing split screens for assessment of 3D content.

### BACKGROUND OF THE INVENTION

In order to compare two or more sequences of comparable content, a player can display, at the same time, at least a portion of the content on a single screen or in other instances on multiple screens. Such a technique is commonly referred to as a split screen. The most common split screen techniques include vertical split screen and vertical butterfly split screen modes. For example, FIG. 1a depicts a representative diagram of the display of original frames of a 2D sequence and FIG. 1b depicts a representative diagram of the display of an encoded version of the original frames of the 2D sequence of FIG. 1a. To compare such sequences a split screen technique can be use. For example, FIG. 2a depicts a representative diagram of the original frames of the 2D sequence of FIG. 1a and the encoded version of the original frames of the 2D sequence of FIG. 1b displayed in a vertical split screen orientation in accordance with a prior art split screen technique. As illustrated in FIG. 2a, the vertical split screen technique provides a visual means for assessing the accuracy of, for example, an encoding process by enabling the side-by-side comparison of the original sequence with the encoded sequence.

The butterfly vertical split screen can also be useful in making such comparisons. For example, FIG. 2b depicts a representative diagram of the original frames of the 2D sequence of FIG. 1a and the encoded version of the original frames of the 2D sequence of FIG. 1b displayed in a vertical butterfly split screen orientation in accordance with a prior art split screen technique. As illustrated in FIG. 2b, the vertical butterfly split screen technique provides a visual means for assessing the accuracy of, for example, an encoding process by enabling the side-by-side comparison of the original sequence with the encoded sequence.

Although such split screen techniques work well for two-dimensional content, the vertical split screen mode can exhibit various deficiencies in the display of three-dimensional content. More specifically, when split screen techniques are applied to three-dimensional content, the boundary between the images/screens can display an abrupt change of disparity. In addition, the reconstructed three-dimensional image of one area/image can overlap with the other area/image. Even further, in instances in which a butterfly mode is used for split screen techniques, the three-dimensional images have the disparities (depth) inverted.

### SUMMARY OF THE INVENTION

Embodiments of the present invention address the deficiencies of the prior art by providing a method, apparatus and system for correcting display problems associated with displaying 3D content in split screen modes.

In one embodiment of the present invention, a method for the visual inspection of a three-dimensional video stream as it is being re-encoded into a second video format includes splitting a decoded three-dimensional video stream into at least two decoded video streams, re-encoding one of the at least two split three-dimensional video streams into the second video format, arranging at least a portion of a frame of the decoded three-dimensional video stream not having been re-encoded and a corresponding portion of a frame of the re-encoded three-dimensional video stream into a combined video frame such that the decoded three-dimensional video frame portion and the corresponding re-encoded three-dimensional video frame portion appear together in the combined video frame, and obstructing the view of the boundary between the decoded three-dimensional video frame portion and the corresponding re-encoded three-dimensional video frame portion such that a change of disparity on the boundary between the decoded three-dimensional video frame portion and the corresponding re-encoded three-dimensional video frame portion, and any overlap there between, are not visible.

In an alternate embodiment of the present invention an apparatus for the visual inspection of a decoded three-dimensional video stream as it is being re-encoded into a second video format, where the three-dimensional video stream comprises a left eye video stream and a right eye video stream, includes a means for arranging at least a portion of a frame of the left eye video stream or the right eye video stream of the decoded three-dimensional video stream and a corresponding portion of a frame of a left eye video stream or a right eye video stream of a split copy of the decoded three-dimensional video stream having been re-encoded into the second format into a combined video frame such that the decoded three-dimensional video frame portion and the corresponding re-encoded three-dimensional video frame portion appear together in the combined video frame. The apparatus further includes a means for manipulating the view of a boundary between the decoded three-dimensional video frame portion and the corresponding re-encoded three-dimensional video frame portion such that a change of disparity on the boundary between the decoded three-dimensional video frame portion and the corresponding re-encoded three-dimensional video frame portion, and overlap between the decoded three-dimensional video frame portion and the corresponding re-encoded three-dimensional video frame portion, are not visible.

In an alternate embodiment of the present invention, a system for the visual inspection of a three-dimensional video stream as it is being re-encoded into a second video format includes a video decoder for decoding a three-dimensional video stream having a left eye video stream and a right eye video stream, aa stream splitter for splitting the decoded three-dimensional video stream into at least two decoded three-dimensional video streams, an encoder for receiving one of the at least two decoded video streams and re-encoding the received one of the at least two decoded video streams into the second video format, at least one video mixer for arranging at least a portion of a frame of the left eye video stream or the right eye video stream of the decoded three-dimensional video stream not having been re-encoded and a corresponding portion of a frame of the left eye video stream or the right eye video stream of the re-encoded three-dimensional video stream into a combined video frame such that the decoded three-dimensional video frame portion and the corresponding re-encoded three-dimensional video frame portion appear together in the combined video frame, and a renderer for manipulating the view of a boundary between the decoded three-dimensional video frame portion and the corresponding re-encoded three-dimensional video frame portion such that a change of disparity on the boundary between the decoded three-dimensional video frame portion and the corresponding re-encoded three-dimensional video frame portion, and overlap between the decoded three-dimensional video frame portion and the corresponding re-encoded three-dimensional video frame portion, are not visible. In one embodiment of the present invention, the system can further include a display device for displaying the mixed and rendered portions of the video frames in the combined video frame.

### BRIEF DESCRIPTION OF THE DRAWINGS

The teachings of the present invention can be readily understood by considering the following detailed description in conjunction with the accompanying drawings, in which:

FIG. 1a depicts a representative diagram of the display of original frames of a 2D sequence;

FIG. 1b depicts a representative diagram of the display of an encoded version of the original frames of the 2D sequence of FIG. 1a;

FIG. 2a depicts a representative diagram of the original frames of the 2D sequence of FIG. 1a and the encoded version of the original frames of the 2D sequence of FIG. 1b displayed in a vertical split screen orientation in accordance with a prior art split screen technique;

FIG. 2b depicts a representative diagram of the original frames of the 2D sequence of FIG. 1a and the encoded version of the original frames of the 2D sequence of FIG. 1b displayed in a vertical butterfly split screen orientation in accordance with a prior art split screen technique;

FIG. 3a depicts a representative diagram of the display of left and right original frames of a 3D sequence;

FIG. 3b depicts a representative diagram of the display of an encoded version of the left and right original frames of the 3D sequence of FIG. 3a;

FIG. 4a depicts a representative diagram of the left and right original frames of the 3D sequence of FIG. 3a and the encoded version of the left and right original frames of the 3D sequence of FIG. 3b displayed in a vertical split screen orientation in accordance with a prior art split screen technique;

FIG. 4b depicts a representative diagram of the left and right original frames of the 3D sequence of FIG. 3a and the encoded version of the left and right original frames of the 3D sequence of FIG. 3b displayed in a vertical butterfly split screen orientation in accordance with a prior art split screen technique;

FIG. 5a depicts a representative diagram of the left and right original frames of the 3D sequence of FIG. 3a and the encoded version of the left and right original frames of the 3D sequence of FIG. 3b displayed in a vertical split screen orientation in accordance with an embodiment of the present invention;

FIG. 5b depicts a representative diagram of the left and right original frames of the 3D sequence of FIG. 3a and the encoded version of the left and right original frames of the 3D sequence of FIG. 3b displayed in a vertical butterfly split screen orientation in accordance with an embodiment of the present invention;

FIG. 6 depicts a high level block diagram of a system for correctly displaying 3D content in split screen modes in accordance with an embodiment of the present invention;

FIG. 7 depicts a high level block diagram of a 3D encoding/decoding system 700 in which an embodiment of the present invention can be applied in accordance with an embodiment of the present invention; and

FIG. 8 depicts a high level flow diagram of a method for the visual inspection of a three-dimensional video stream as it is being re-encoded into a second video format in accordance with an embodiment of the present invention.

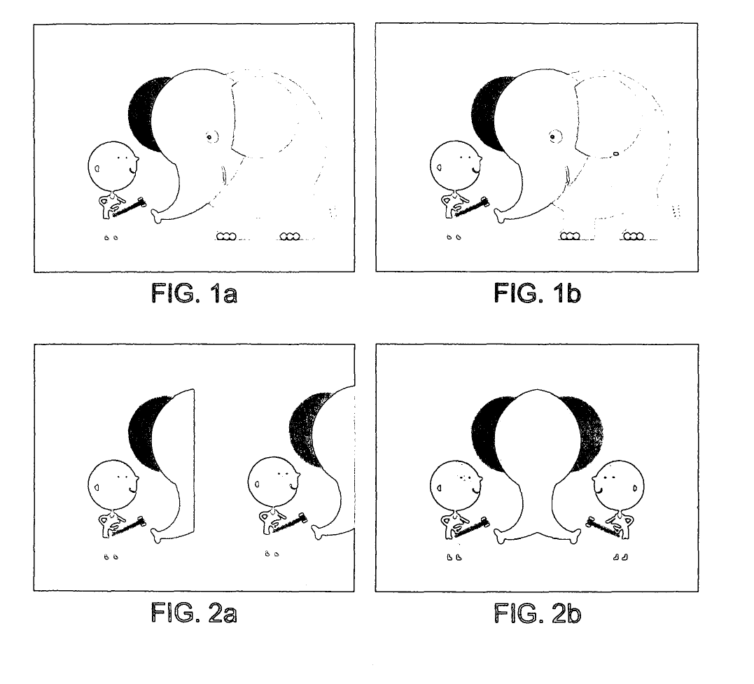

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for correcting display problems associated with displaying 3D content in split screen modes. Although the present invention will be described primarily within the context of correcting disparity errors by implementing a vertical opaque or black bar or space between the boundary of two images, the specific embodiments of the present invention should not be treated as limiting the scope of the invention. It will be appreciated by those skilled in the art and informed by the teachings of the present invention that the concepts of the present invention can be accomplished using a blocking or spacing means having substantially any shape, color, orientation or size in the boundary between two or more images.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

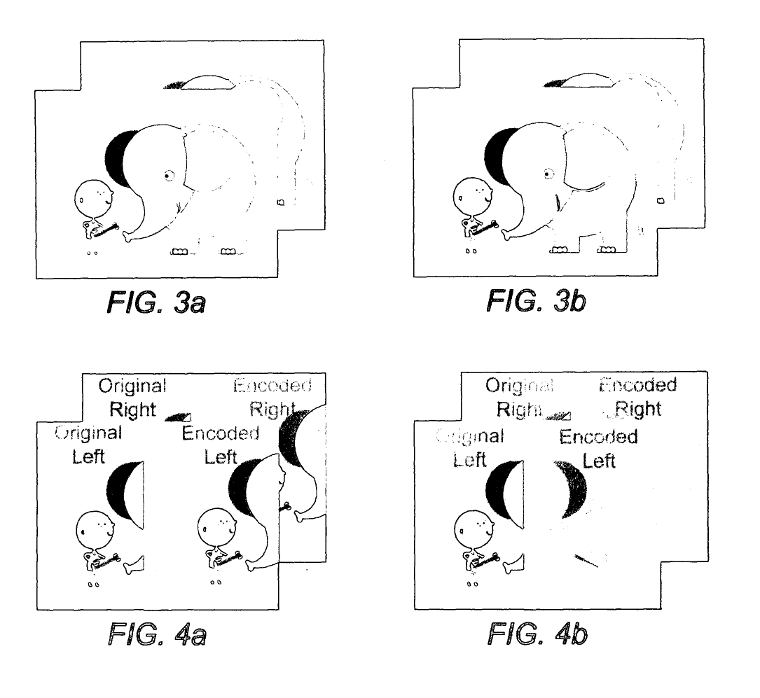

As previously mentioned, although split screen techniques work well for two-dimensional content, the vertical split screen mode can exhibit various deficiencies in the display of three-dimensional content. More specifically, when split screen techniques are applied to three-dimensional content, the boundary between the images/screens can display an abrupt change of disparity. In addition, the reconstructed three-dimensional image of one area/image can overlap with the other area/image. For example, FIG. 3a depicts a representative diagram of the display of left and right original frames of a 3D sequence and FIG. 3b depicts a representative diagram of the display of an encoded version of the left and right original frames of the 3D sequence of FIG. 3a.

In order to compare such sequences, the content can be arranged in a vertical split screen orientation. For example, FIG. 4a depicts a representative diagram of the left and right original frames of the 3D sequence of FIG. 3a and the encoded version of the left and right original frames of the 3D sequence of FIG. 3b displayed in a vertical split screen orientation in accordance with a prior art split screen technique. That is, in FIG. 4a, the image of the left original frames of the 3D sequence is displayed in a vertical split screen orientation with the image of the left encoded frames of the 3D sequence and the image of the right original frames of the 3D sequence is displayed in vertical split screen orientation with the image of the right encoded frames of the 3D sequence. As depicted in FIG. 4a, the reconstructed three-dimensional image of the left original frames of the 3D sequence overlap with the image of the left encoded frames of the 3D sequence. The same holds true for the image of the right original frames of the 3D sequence and the image of the right encoded frames of the 3D sequence. From FIG. 4a it can also be seen that the boundary between the images/screens of the respective images display an abrupt change of disparity.

Problems associated with applying a vertical butterfly split screen technique are illustrated in FIG. 4b. For example, FIG. 4b depicts a representative diagram of the left and right original frames of the 3D sequence of FIG. 3a and the encoded version of the left and right original frames of the 3D sequence of FIG. 3b displayed in a vertical butterfly split screen orientation in accordance with a prior art split screen technique. That is, in FIG. 4b, the image of the left original frames of the 3D sequence is displayed in a vertical butterfly split screen orientation with the image of the left encoded frames of the 3D sequence and the image of the right original frames of the 3D sequence is displayed in a vertical butterfly split screen orientation with the image of the right encoded frames of the 3D sequence. As depicted in FIG. 4b, the depth of the reconstructed three-dimensional image of the left original frames of the 3D sequence becomes inverted with the image of the left encoded frames of the 3D sequence. The same holds true for the depth of the image of the right original frames of the 3D sequence with respect to the image of the right encoded frames of the 3D sequence. More specifically, in instances in which a butterfly mode is used for split screen techniques, the three-dimensional images have the disparities (depth) inverted.

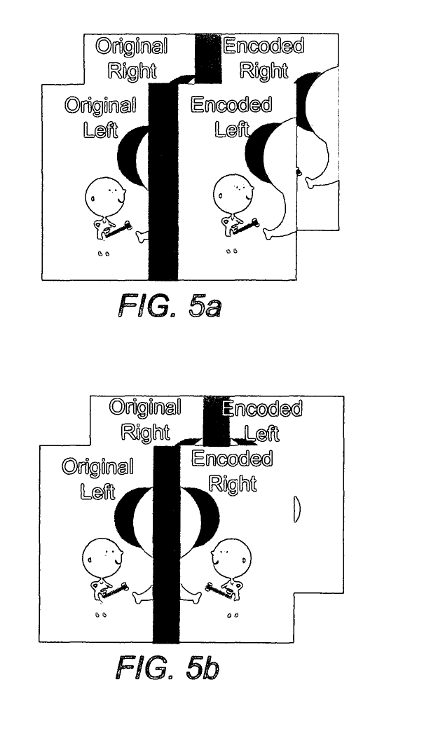

In one embodiment of the present invention, to address the above described deficiencies of the prior art vertical split screen techniques and more specifically, in order to avoid the eventual abrupt change of disparity on the boundary of the vertical split screen technique and also to avoid the overlap between one area with the other one, the inventors propose to render a vertical bar on the boundary between displayed images. For example, FIG. 5a depicts a representative diagram of the left and right original frames of the 3D sequence of FIG. 3a and the encoded version of the left and right original frames of the 3D sequence of FIG. 3b displayed in a vertical split screen orientation in accordance with an embodiment of the present invention. That is, in FIG. 5a, the image of the left original frames of the 3D sequence is displayed in a vertical split screen orientation with the image of the left encoded frames of the 3D sequence and the image of the right original frames of the 3D sequence is displayed in vertical split screen orientation with the image of the right encoded frames of the 3D sequence. As depicted in FIG. 5a, a vertical black bar is placed on the boundary between the original image and the encoded image to obstruct the view of any overlap between the image of the left/right original frames of the 3D sequence and the image of the left/right encoded frames of the 3D sequence.

In accordance with concepts of the present invention, the vertical black bar of the embodiment of FIG. 5a is also used to obstruct the view of any abrupt change of disparity in the boundary between the image of the left/right original frames of the 3D sequence and the image of the left/right encoded frames of the 3D sequence.

In one embodiment of the present invention, the thickness of the vertical bar of the present invention can be determined using the disparity value between the left and right views of the two sources of the 3D content. In an alternate embodiment of the present invention, the thickness of the vertical bar of the present invention can be selected by a user from among a plurality of thicknesses made available to a user. For example, in such an embodiment of the present invention, a user can select from among thicknesses of 50, 100 or 150 pixels for the thickness of the vertical bar of the present invention.

In an alternate embodiment of the present invention, to address the above described deficiencies of the prior art vertical split screen techniques and more specifically, in order to avoid the eventual abrupt change of disparity on the boundary of the vertical split screen technique and also to avoid the overlap between one area with the other one, the inventors propose to render an offset in the boundary between two images. More specifically, in an alternate embodiment of the present invention, instead of rendering a vertical bar on the boundary between images as in the embodiment of FIG. 5a, an offset in the boundary between two images can be used. Similar to the embodiment of FIG. 5a, in such an embodiment of the present invention described herein, the size of the offset between images of the present invention can be determined using the disparity value between the left and right views of the two sources of the 3D content. In an alternate embodiment of the present invention, the size of the offset of the present invention can be selected by a user from among a plurality of offset sizes made available to a user. For example, in such an embodiment of the present invention, a user can select from among offset sizes of 50, 100 or 150 pixels for the size of the offset of the present invention.

In one embodiment of the present invention, to address the above described deficiencies of the prior art vertical butterfly split screen techniques and more specifically, in order to correct for inverted disparities (depth) between three-dimensional images, the inventors propose to swap left and right views of the source that will have the butterfly effect. For example, FIG. 5b depicts a representative diagram of the left and right original frames of the 3D sequence of FIG. 3a and the encoded version of the left and right original frames of the 3D sequence of FIG. 3b displayed in a vertical butterfly split screen orientation in accordance with an embodiment of the present invention. That is, as depicted in FIG. 5b, the image of the left original frames of the 3D sequence is displayed in a vertical split screen orientation with the image of the right encoded frames of the 3D sequence and the image of the right original frames of the 3D sequence is displayed in vertical split screen orientation with the image of the left encoded frames of the 3D sequence. The inventors have determined that such an orientation corrects for inverted disparities (depth) in the display of three-dimensional images in a vertical butterfly split screen orientation.

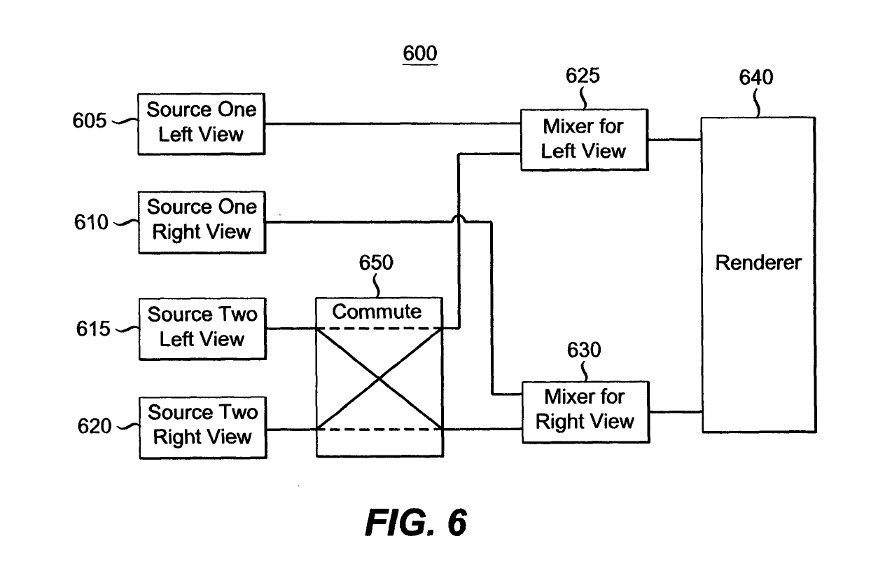

FIG. 6 depicts a high level block diagram of an apparatus/system for correctly displaying 3D content in split screen modes in accordance with an embodiment of the present invention. The apparatus/system 600 of FIG. 6 illustratively includes first and second sources of 3D content. More specifically, FIG. 6 illustratively includes a source one of a left view of content 605, a source one of a right view of content 610, a source two of a left view of content 615, and a source two of a right view of content 620. In one embodiment of the present invention, the sources one of the left and right views of content comprise original left view and right view streams of content used to produce a 3D video stream. In such an embodiment of the present invention, the sources two of the left and right views of content comprise re-encoded split streams of the original left view and right view streams of content used to produce the 3D video stream. In an alternate embodiment of the present invention, the sources two of the left and right views of content instead comprise original left view and right view streams of content used to produce a 3D video stream and the sources one of the left and right views of content comprise re-encoded split streams of the original left view and right view streams of content used to produce the 3D video stream.

The apparatus/system 600 of FIG. 6 further includes a mixer 625 for left views, a mixer 630 for right views and a renderer 640 for rendering images. The apparatus/system 600 of FIG. 6 further optionally includes a commute device 650.

In the embodiment of the present invention depicted in the apparatus/system 600 of FIG. 6, the left content from the two left sources 605, 615 (e.g., the original content stream and the re-encoded content stream) are mixed in the left view mixer 625. In addition, the right content from the two right sources 610 and 620 (e.g., the original content stream and the re-encoded content stream) are mixed in the right view mixer 630. The mixed content from the mixers 625, 630 are then communicated to the renderer 640 for producing the images and in one embodiment the vertical split screen images in accordance with an embodiment of the present invention. More specifically, in accordance with one embodiment of the present invention, the renderer 640 enables the display of the images in a vertical split screen orientation for comparison as described above, and in one embodiment applies the inventive concept to the images.

More specifically, in accordance with an embodiment of the present invention, the renderer 640 prepares the images for display in a vertical split screen mode and applies the vertical bar of the present invention in the boundary between the images in the vertical split screen mode. In an alternate embodiment of the present invention, the renderer 640 prepares the images for display in a vertical split screen mode and applies an offset, as identified in the various embodiments of the present invention described herein, in the boundary between the images in the vertical split screen mode.

In instances in which the images are to be displayed in a vertical butterfly split screen mode, the optional commute device 650 of the apparatus/system 600 of FIG. 6 is implemented. More specifically, the commute device 650 of the present invention is used to swap the left and right views of at least one of the sources of content to correct for inverted disparities (depth) in the display of three-dimensional images in a vertical butterfly split screen orientation as described above.

Although in the apparatus/system 600 of FIG. 6, the commute device 650 is illustratively a separate component of the apparatus/system 600, in alternate embodiments of the present invention, the commute device 650 can be an integrated component of the mixers 625, 630 or the renderer 640. In addition, although in the embodiment of FIG. 6, the rendered 640, the mixers 625, 630 and the commute device 650 are depicted as comprising separate components, in an alternate embodiment of the present invention, the components can comprise a single apparatus in hardware or in software.

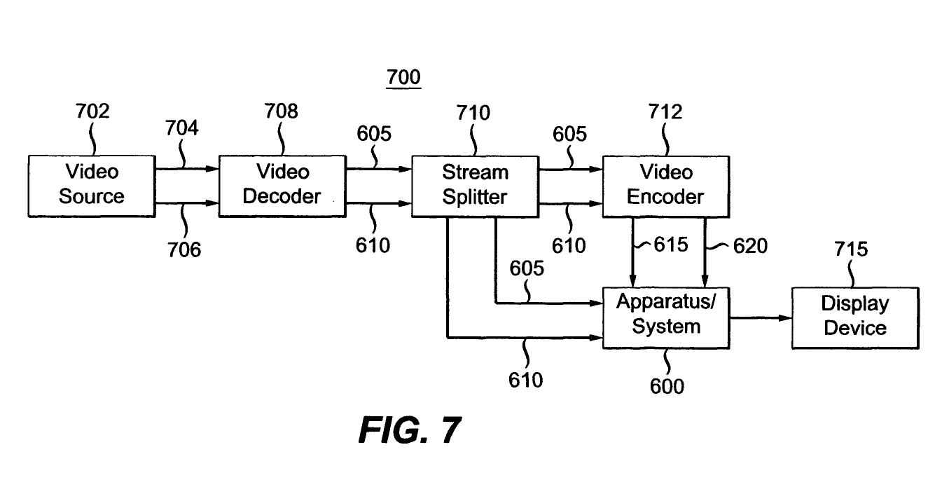

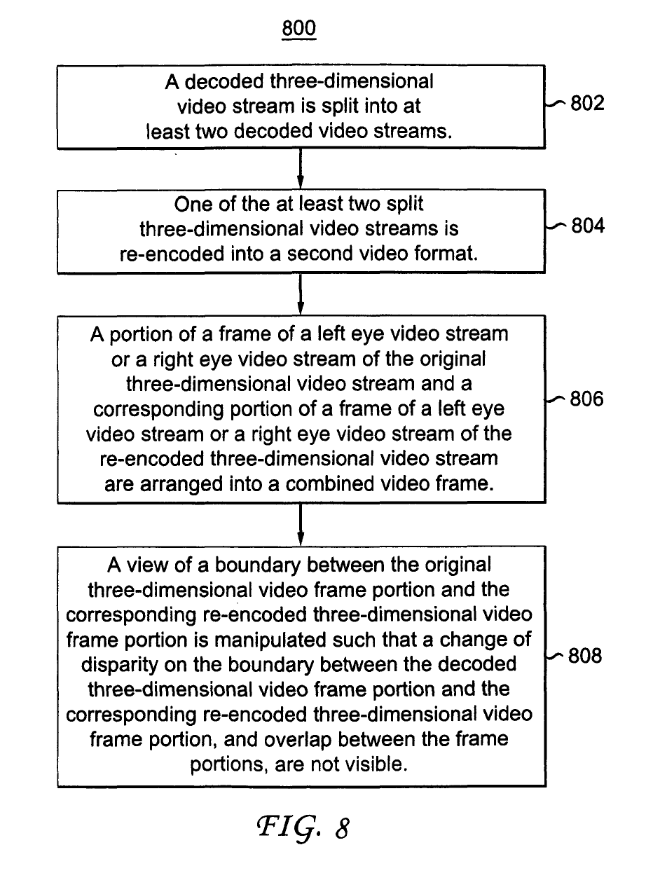

FIG. 7 depicts a high level block diagram of a 3D encoding/decoding system 700 in which an embodiment of the present invention can be applied. The system 700 of FIG. 7 illustratively includes a source 702 of a 3D video stream, the video stream having a left eye video stream 704 and a right eye video stream 706. The system 700 further includes a video decoder 708, a stream splitter 710, an encoder 712 and the apparatus/system 600 of FIG. 6.

In the system 700 FIG. 7, the left eye video stream 704 and right eye video stream 706 are decoded by the decoder 708 into a decoded left eye video stream 605 and right eye video stream 610 and communicated to the stream splitter 710 to be split into two decoded 3D video streams. The left eye video stream 605 and right eye video stream 620 are split by the stream splitter 710 and a first split 3D video stream is communicated to the apparatus/system 600 of FIG. 6 as, in one embodiment, a source one of a left view of content 605 and a source one of a right view of content 610. In the system 700 of FIG. 7, a second split 3D video stream is communicated to the encoder 712 to be encoded. The left eye video stream 605 and the right eye video stream 610 of the second split 3D video stream re-encoded by the encoder, are communicated to the apparatus/system 600 of FIG. 6 as, in one embodiment, a source two of a left view of content 615, and a source two of a right view of content 620. The left and right eye video streams of the decoded 3D video stream and the re-encoded video stream are then processed as described above with reference to the apparatus/system 600 of FIG. 6 and in accordance with the described embodiments of the present invention. The system 700 of FIG. 7 can optionally further include a display device 715 for displaying the portions of the video frames in the combined video frame.

FIG. 8 depicts a high level flow diagram of a method for the visual inspection of a three-dimensional video stream as it is being re-encoded into a second video format in accordance with an embodiment of the present invention. The method 800 of FIG. 8 illustratively begins at step 802 during which a decoded three-dimensional video stream having a left eye video stream and a right eye video stream is split into at least two decoded video streams, each video stream comprising a left eye video stream and a right eye video stream. The method 800 then proceeds to step 804.

At step 804, one of the at least two split three-dimensional video streams is re-encoded into a second video format. The method 800 then proceeds to step 806.

At step 806, at least a portion of a frame of the left eye video stream or the right eye video stream of the decoded three-dimensional video stream not having been re-encoded and a corresponding portion of a frame of the left eye video stream or the right eye video stream of the re-encoded three-dimensional video stream are arranged into a combined video frame such that the decoded three-dimensional video frame portion and the corresponding re-encoded three-dimensional video frame portion appear together in a combined video frame. The method then proceeds to step 808.

At step 808, a view of a boundary between the decoded three-dimensional video frame portion and the corresponding re-encoded three-dimensional video frame portion is manipulated such that a change of disparity on the boundary between the decoded three-dimensional video frame portion and the corresponding re-encoded three-dimensional video frame portion, and overlap between the frame portions, are not visible. In one embodiment of the present invention, the manipulation includes inserting a vertical black bar in the boundary between the decoded three-dimensional video frame portion and the corresponding re-encoded three-dimensional video frame portion. In an alternate embodiment of the present invention, the manipulation includes applying an offset in a boundary between the decoded three-dimensional video frame portion and the corresponding re-encoded three-dimensional video frame portion. The method 800 can then be exited.

Having described various embodiments for a method, apparatus and system for correctly displaying 3D content in split screen modes (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for the visual inspection of a three-dimensional video stream as it is being re-encoded into a second video format, comprising:
splitting a decoded three-dimensional video stream having a left eye video stream and a right eye video stream into at least two decoded video streams, each video stream comprising a left eye video stream and a right eye video stream;
re-encoding one of said at least two split three-dimensional video streams into the second video format;
arranging at least a portion of a frame of the left eye video stream or the right eye video stream of the decoded three-dimensional video stream not having been re-encoded and a corresponding portion of a frame of the left eye video stream or the right eye video stream of the re-encoded three-dimensional video stream into a combined video frame such that said decoded three-dimensional video frame portion and said corresponding re-encoded three-dimensional video frame portion appear together in the combined video frame; and
manipulating the view of a boundary between said decoded three-dimensional video frame portion and said corresponding re-encoded three-dimensional video frame portion such that a change of disparity on the boundary between said decoded three-dimensional video frame portion and said corresponding re-encoded three-dimensional video frame portion, and overlap between said decoded three-dimensional video frame portion and said corresponding re-encoded three-dimensional video frame portion, are not visible.

2. The method of claim 1, wherein said manipulating comprises inserting a vertical black bar in said boundary between said decoded three-dimensional video frame portion and said corresponding re-encoded three-dimensional video frame portion.

3. The method of claim 2, wherein a width of said vertical black bar is determined using a disparity value between corresponding frames of said left and right eye video streams of said three-dimensional video stream.

4. The method of claim 1, wherein said decoded three-dimensional video frame portion and corresponding re-encoded three-dimensional video frame portion are arranged in the combined video frame to appear side-by-side.

5. The method of claim 4, wherein said decoded three-dimensional video frame portion comprises at least a portion of a video frame from the left eye video stream of said decoded three-dimensional video stream and said corresponding re-encoded three-dimensional video frame portion comprises at least a portion of a video frame from the left eye video stream of said corresponding re-encoded three-dimensional video stream or said decoded three-dimensional video frame portion comprises at least a portion of a video frame from the right eye video stream of said decoded three-dimensional video stream and said corresponding re-encoded three-dimensional video frame portion comprises at least a portion of a video frame from the right eye video stream of said corresponding re-encoded three-dimensional video stream and said video frame portions are arranged in the combined video frame to appear side-by-side.

6. The method of claim 1, wherein said decoded three-dimensional video frame portion and corresponding re-encoded three-dimensional video frame portion are arranged in the combined video frame such that the video frame portions appear inverted along the y-axis with respect to one another.

7. The method of claim 6, wherein said decoded three-dimensional video frame portion comprises at least a portion of a video frame from the left eye video stream of said decoded three-dimensional video stream and said corresponding re-encoded three-dimensional video frame portion comprises at least a portion of a video frame from the right eye video stream of said corresponding re-encoded three-dimensional video stream and said video frame portions are arranged in the combined video frame such that the video frame portions appear inverted along the y-axis with respect to one another.

8. The method of claim 6, wherein said decoded three-dimensional video frame portion comprises at least a portion of a video frame from the right eye video stream of said decoded three-dimensional video stream and said corresponding re-encoded three-dimensional video frame portion comprises at least a portion of a video frame from the left eye video stream of said corresponding re-encoded three-dimensional video stream and said video frame portions are arranged in the combined video frame such that the video frame portions appear inverted along the y-axis with respect to one another.

9. The method of claim 1, wherein said manipulating comprises applying an offset in a boundary between said decoded three-dimensional video frame portion and said corresponding re-encoded three-dimensional video frame portion.

10. The method of claim 9, wherein a size of said offset is determined using a disparity value between corresponding frames of said left and right eye video streams of said three-dimensional video stream.

11. An apparatus for the visual inspection of a decoded three-dimensional video stream as it is being re-encoded into a second video format, wherein said three-dimensional video stream comprises a left eye video stream and a right eye video stream, said apparatus comprising:
means for arranging at least a portion of a frame of the left eye video stream or the right eye video stream of the decoded three-dimensional video stream and a corresponding portion of a frame of a left eye video stream or a right eye video stream of a split copy of the decoded three-dimensional video stream having been re-encoded into the second format into a combined video frame such that said decoded three-dimensional video frame portion and said corresponding re-encoded three-dimensional video frame portion appear together in the combined video frame; and
means for manipulating the view of a boundary between said decoded three-dimensional video frame portion and said corresponding re-encoded three-dimensional video frame portion such that a change of disparity on the boundary between said decoded three-dimensional video frame portion and said corresponding re-encoded three-dimensional video frame portion, and overlap between said decoded three-dimensional video frame portion and said corresponding re-encoded three-dimensional video frame portion, are not visible.

12. The apparatus of claim 11 further comprising:
means for swapping the portion of the frame of the left eye video stream or the right eye video stream of the decoded three-dimensional video stream or the re-encoded three-dimensional video stream in the combined frame.

13. The apparatus of claim 12, wherein said swapping is performed to correct for inverted disparities in the display of three-dimensional images in a vertical butterfly split screen orientation.

14. A system for the visual inspection of a three-dimensional video stream as it is being re-encoded into a second video format, comprising:
a video decoder for decoding a three-dimensional video stream having a left eye video stream and a right eye video stream;
a stream splitter for splitting the decoded three-dimensional video stream into at least two decoded three-dimensional video streams;
an encoder for receiving one of said at least two decoded video streams and re-encoding the received one of said at least two decoded video streams into the second video format;
at least one video mixer for arranging at least a portion of a frame of the left eye video stream or the right eye video stream of the decoded three-dimensional video stream not having been re-encoded and a corresponding portion of a frame of the left eye video stream or the right eye video stream of the re-encoded three-dimensional video stream into a combined video frame such that said decoded three-dimensional video frame portion and said corresponding re-encoded three-dimensional video frame portion appear together in the combined video frame; and
a renderer for manipulating the view of a boundary between said decoded three-dimensional video frame portion and said corresponding re-encoded three-dimensional video frame portion such that a change of disparity on the boundary between said decoded three-dimensional video frame portion and said corresponding re-encoded three-dimensional video frame portion, and overlap between said decoded three-dimensional video frame portion and said corresponding re-encoded three-dimensional video frame portion, are not visible.

15. The system of claim 14 further comprising:
a commute for swapping the portion of the frame of the left eye video stream or the right eye video stream of the decoded three-dimensional video stream or the re-encoded three-dimensional video stream in the combined frame.

16. The system of claim 14, further comprising:
a display device for displaying the mixed and rendered portions of the video frames in the combined video frame.
